(19) United States
(12) Patent Application Publication
(10) Pub. No.: US 2004/0249871 A1
(43) Pub. Date: Dec. 9, 2004

(54) System and method for automatically removing documents from a knowledge repository

(76) Inventor: Mehdi Bazoon, San Jose, CA (US)

Correspondence Address: HEWLETT-PACKARD COMPANY, Intellectual Property Administration, P O Box 272400, Fort Collins, CO, 80527-2400, US

(21) Appl. No.: 10/444,835

(22) Filed: May 22, 2003

(51) Int. Cl. G06F 17/30

(52) U.S. Cl. 707/206

(57) ABSTRACT

A system and method is provided for automatically removing documents from a knowledge repository. The invention includes the operation of assigning a storage period to documents in the knowledge repository. A further operation is reducing the storage period for documents as time passes. An additional operation is identifying whether documents are useful to users. The storage period of documents is updated based on the documents' usefulness to users. Then the documents that have an expired storage period are removed.

### FIELD OF THE INVENTION

The present invention relates generally to removing documents from a knowledge repository.

### BACKGROUND

The Internet as a network of connected computers has existed for several decades, but more recently the World Wide Web was widely adopted in the mid-1990s. The Web uses hypertext markup language documents (HTML) as a base structure and distributes these documents and other multimedia using hypertext transfer protocol (HTTP). The relatively intuitive Web interface has allowed many companies and individuals to distribute information through the Internet. Extensions have also been made to this architecture to provide more dynamic web pages, e.g. Java, Active Server Pages and streaming video.

This powerful medium for distributing information has been adopted by many companies or entities that need to provide information, documents, and similar multimedia content to their clients, customers, and product users. The need to deliver a large volume of documents and related multimedia information has resulted in the creation of knowledge repositories which contain thousands of multimedia documents relating to a company's products, product support, or similar valuable information. As a result of the need to organize, manage and deliver this content, many vendors provide portal content and document management tools to those who need these services. These document management tools typically include programs to organize content, publish content, create user sessions, and provide a user interface.

As knowledge repositories have been used more extensively, the size of the knowledge repositories and their document databases grows. This is because more documents are added to the database. The drawback to the growth of these types of databases is that users may find it more difficult to locate relevant documents for their problems or needs. This is especially true if the user is not capable of entering a well-focused search that brings up a related document. There may also be a number of other unrelated documents that are brought up by the search. Thus, it can be difficult to identify which documents are most relevant to a problem or piece of information the user wants.

When document repositories grow, it creates problems for the document management system. One problem is that the computer hardware has to deal with more data and content which slows down the processing of the overall system. Specifically, the computer systems take more time to process the search calculations on the search indexes when the search indexes become relatively large. It also takes more time to retrieve the data as the size of the knowledge repository grows.

Hiding or removing outdated document content is important because outdated content can lower the quality of searches or queries by filling the search results with irrelevant and distracting source documents. For instance, some search engines never remove the documents that are retrieved in a search and thus their search results continually get larger.

Although it is important to remove outdated documents, system administrators who oversee large knowledge repositories generally do not have a significant amount of time to devote to document removal. What frequently happens is that the search engine's search calculations will become rather large or the number of documents in the knowledge repository or database will become relatively large. At that point, one of the system administrators will be assigned to cull documents from the knowledge repository. Some vendors of document management products recommend that a system administrator should archive old content as part of a semi-annual or annual review of the knowledge repository.

The conventional method of identifying documents that should be removed or culled from a knowledge repository is by dating the documents. Each document may be assigned a creation date and the system administrator can decide whether to remove the document based on the original creation date. When the time arrives for the system administrator to remove documents, a search is performed to see which documents are older than a specific date criteria. Documents that are older than a specific date criteria can then be removed from the database. Typically, system administrators will check the database every six months or year to determine when documents can be removed.

Of course, applying a date to a document does not account for the situation where a document is created but the document date is accidentally omitted. In this situation, the system administrator has no idea whether or not the document should be deleted at a later time. As a result, the knowledge repository may become littered with irrelevant or extraneous documents.

One of the reasons system administrators do not have time to spend with document removal is that their focus and measure of productivity is generally focused upon the creation and organization of documents. System administrators are generally rewarded by the individuals or businesses, who own a knowledge repository, when new and interesting content is added to the database. As a result, the removal of documents from the database is just an afterthought. In addition, system administrators are also more concerned about document publishing, user interfaces, and the underlying computing system than they are about obsolete documents. What most system administrators do not realize is that the user interface and the accessibility of published documents are significantly affected by the total amount of relevant (or irrelevant) documents contained in the knowledge repository.

### SUMMARY OF THE INVENTION

The invention provides a system and method for automatically removing documents from a knowledge repository. The invention includes the operation of assigning a storage period to documents in the knowledge repository. A further operation is reducing the storage period for documents as time passes. An additional operation is identifying whether the documents are useful to users. The storage period of documents is updated based on the documents' usefulness to users. Then the documents that have an expired storage period are removed.

### BRIEF DESCRIPTION OF THE DRAWINGS

FIG. 1 is flow chart illustrating operations for automatically removing documents from a knowledge repository in accordance with an embodiment of the present invention;

FIG. 2 is a block diagram of an embodiment of a system for removing documents from a knowledge repository;

FIG. 3 is a flow chart illustrating an embodiment of operations for notifying an interested party that a document may be automatically removed from a knowledge repository unless the interested party desires to keep the document in the knowledge repository;

FIG. 4 is a flow chart illustrating operations that identify useful content in a knowledge repository in accordance with an embodiment of the present invention;

FIG. 5 is a flow chart illustrating an embodiment of the invention that identifies useful documents in a knowledge repository using a time value reference point for a set of document open time values; and

FIG. 6 is a bell shaped curve illustrating a median point and a standard deviation for the set of document open time values in an embodiment of the present invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides a system and method for automatically removing documents from a knowledge repository. The term documents as used in this description is defined to generally include a strictly text document or a document that includes a wide variety of multimedia elements, such as audio, video, digital slides, and similar presentations.

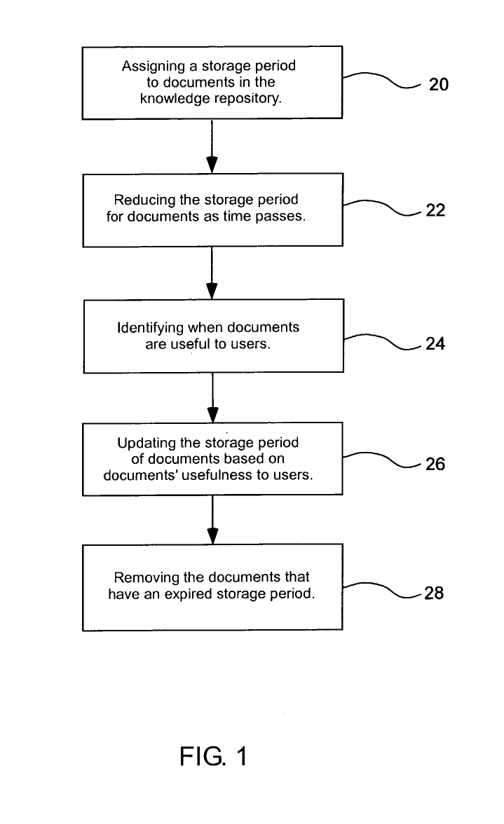

As illustrated in FIG. 1, the method can include the operation of assigning a storage period to documents in the knowledge repository in block 20. The storage period is generally defined as a value or value range, which tracks the amount of time remaining for the document to stay in the database. For example, the storage period may contain a value that represents the document's remaining number of months, days, or hours in the knowledge repository or database. Alternatively, the storage period can be a date and/or time range during which the document is allowed to exist in the knowledge repository.

Another operation is reducing the storage period for documents as time passes in block 22. If the storage period is a counter representing time then the counter can be decremented. For instance, a document that has 180 days remaining to be stored in the knowledge repository can be decremented to 179 days of time remaining in the knowledge repository. This process can repeated each day until the counter reaches 0. Another example is a document that has a date range representing the storage period. As time passes, the storage period is reduced as the system calendar advances.

The present invention can identify whether documents are useful to users in block 24. Methods for calculating the usefulness of documents will be discussed at a later point in this description. The storage period of documents can be updated based on the documents' usefulness to users in block 26. If a document is useful, then time may be added to the document storage period, and this allows the useful document to remain in the database longer. In some situations, the update or modification will simply be keeping the storage period the same as it was before. If the document is not useful, then the system can reduce the storage period of the document and it may be removed from the database sooner than originally intended (unless the document becomes useful before the end of its storage period).

In addition, a date range can be updated and the date range may be shortened or lengthened. For example, if the date for removing the document is December 31 but the document is deemed less useful, then the date for removing the document could be “reduced” to December 30. Alternatively, a useful document could have its life extended from December 31 to January 10. Any number of storage period aging schemes could be devised by one skilled in the art which would fall within the present invention.

When the documents have an expired storage period, then the documents can be automatically removed from the knowledge repository in block 28. In one embodiment, an executable process can be included that runs automatically each day or once every predetermined period to remove multimedia documents from the knowledge repository.

In the past, a measure of the number of times the document was opened has been used to calculate search rankings, but actual document usefulness has not been applied to the problem of determining how long a document should be retained in a knowledge repository. Applying document usefulness to the storage period of a document provides a system and method that removes less useful documents from the knowledge repository and reduces the system's computing workload.

The present invention is also valuable because it retains documents that are more useful to end users. On the other hand, if a document is not useful in the knowledge repository, then the document will be removed faster because the document's storage period will be reduced. In essence, the present invention keeps documents longer when the documents are currently contributing to the knowledge repository and removes documents more quickly when they are not currently contributing to the knowledge repository.

The present system and method avoid an excessively large knowledge repository which contains extraneous documents. This reduces each search index's size and increases the search engine speed for the knowledge repository. Reducing the knowledge repository size by retaining more useful documents also increases the quality of searches returned by the search engine. Otherwise, old and useless documents corrupt the search because irrelevant or inactive documents may appear in users' searches.

Removing irrelevant or inactive documents applies computing resources to a knowledge repository in a more effective manner. An overly large database will consume an inordinate amount of storage space and take more processing time to search because it is not being maintained properly. When the knowledge repository is automatically managed based on the usefulness of documents, then computing resources are allocated more efficiently. This active management can then reduce the amount of computing hardware that is required.

Being able to retain more useful documents helps focus the knowledge repository content and increase the knowledge repository responsiveness. In the past, knowledge repository systems have been more concerned with formatting, modifying, and creating the database content but not with removing documents. Unfortunately, if useless or extraneous documents are not removed from the database, then the upgraded content is more difficult for users to access.

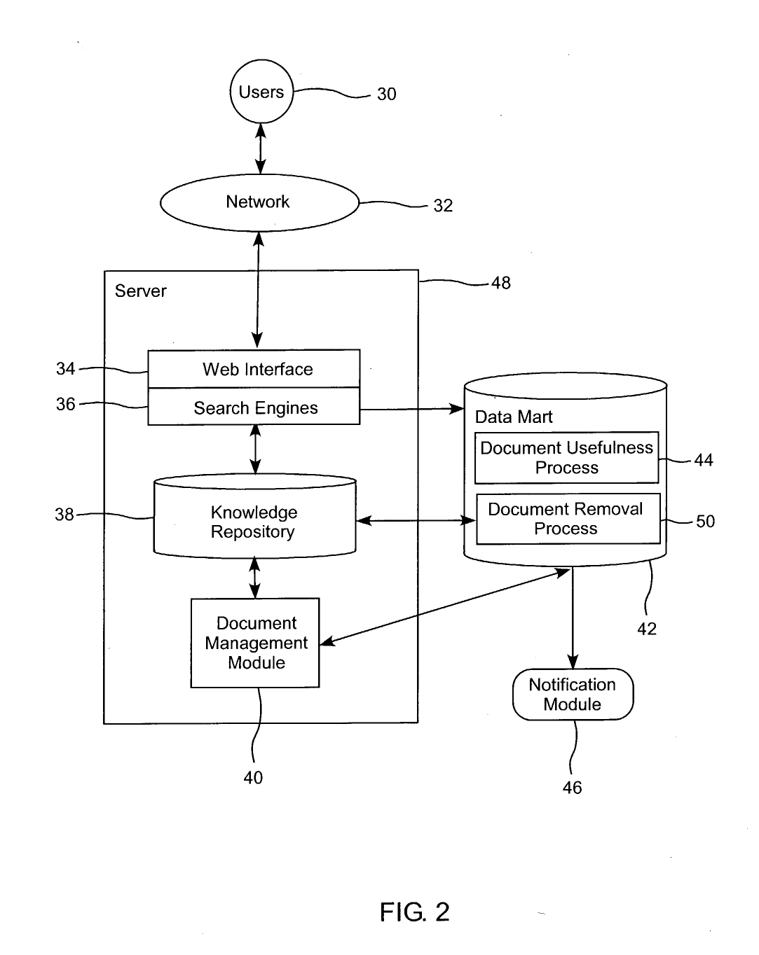

FIG. 2 illustrates a system for removing documents from a knowledge repository accessed by a plurality of users 30 when documents are less useful. The users are able to access the documents and multimedia elements contained on a server 48 through a network 32. The network can be a local area network, wide area network, or the Internet. A knowledge repository 38 (e.g., document database) can store the actual documents and multimedia content that users desire to access. A web interface 34 is configured to communicate with users and to allow access to documents in the knowledge repository. The web interface may contain user session connection information. System security and user security levels can also be setup in the web interface.

One or more search engines 36 are located with or accessed through the web interface 34. The search engines and knowledge repository 38 work in cooperation with a document management module 40. The search engine indexes the documents and allows users 30 to perform a Boolean search query against the search indexes. The search engine may also receive search requests from meta-search engines using an interface other than the web interface.

The document management module 40 and a data mart 42 include specific document management functions. The data mart 42 enables the system to track an amount of time each unique user has a document open to create a set of document open time values. The data mart can also track other document activity metrics as needed. The document management module aids in the formatting, upkeep, and publishing of electronic documents and content in the knowledge repository. Examples of document management modules are software products such as Documentum® or Vignette®. The document notes, creator identity and document creation date can be stored in the document management module. In addition, the document management module can store a working copy of the documents and sync itself with the knowledge repository.

A document usefulness process 44 is located with the data mart 42. The document usefulness process is configured to determine document usefulness based on the comparison of the document open time values for the unique users. Specifically, an individual document open time value will be compared to the set of document open time values. In addition, a time value reference point for the set of document open time values can be used to indicate that a document is useful. The document usefulness process can select the time value reference point which indicates when the document is useful. As will be described later, the time value reference point can be the median of the set of document open time values. The median is used because it is intolerant to outlying values. Other time value reference points can be used such as the average document open time or other statistical reference points.

A storage period can also be associated with each document. The storage period can be a counter which tracks the amount of time for the document to remain in the knowledge repository or a date range during which the document is allowed to exist in the knowledge repository. The storage period value can be stored in the knowledge repository 38, in the document management module 40, data mart 42, or in another accessible location. The document usefulness process 44 or the document removal process 50 can be configured to update the storage period of the document as time passes. For example, the storage period can be increased, reduced, or remain unchanged based on the documents usefulness during each day, week, month, or other pre-determined interval.

A document removal process 50 is included and configured to remove documents from the knowledge repository 38 that have expired storage periods. The document removal process can be in communication with the knowledge repository. It is significant that the document removal process can be configured to be automatically activated at pre-determined intervals to check which documents have expired. For instance, the document removal process can be activated automatically each night to find and remove documents which have no remaining storage period.

The information regarding the storage period for the document can also be disseminated to interested parties. The distribution of information to interested parties or authors is performed through a notification module 46. The notification module is configured to notify an interested party when a document is going to be removed from the knowledge repository. This notification can take place through a web site, email, instant messaging, or additional electronic communication channels. This allows an interested party, such as the system administrator or document author, to pre-empt the removal of a document from the database when appropriate.

In the past, a knowledge repository system has not been able to capture information regarding document transactions and then process that data. This is because the search engine was independent of the document management module and data mart. Further, document usefulness has not been previously related to capturing of aggregate document transactions, usage and time open metrics. Capturing this information allows the system to relate document activity to document usefulness and then document usefulness can be applied to the storage period.

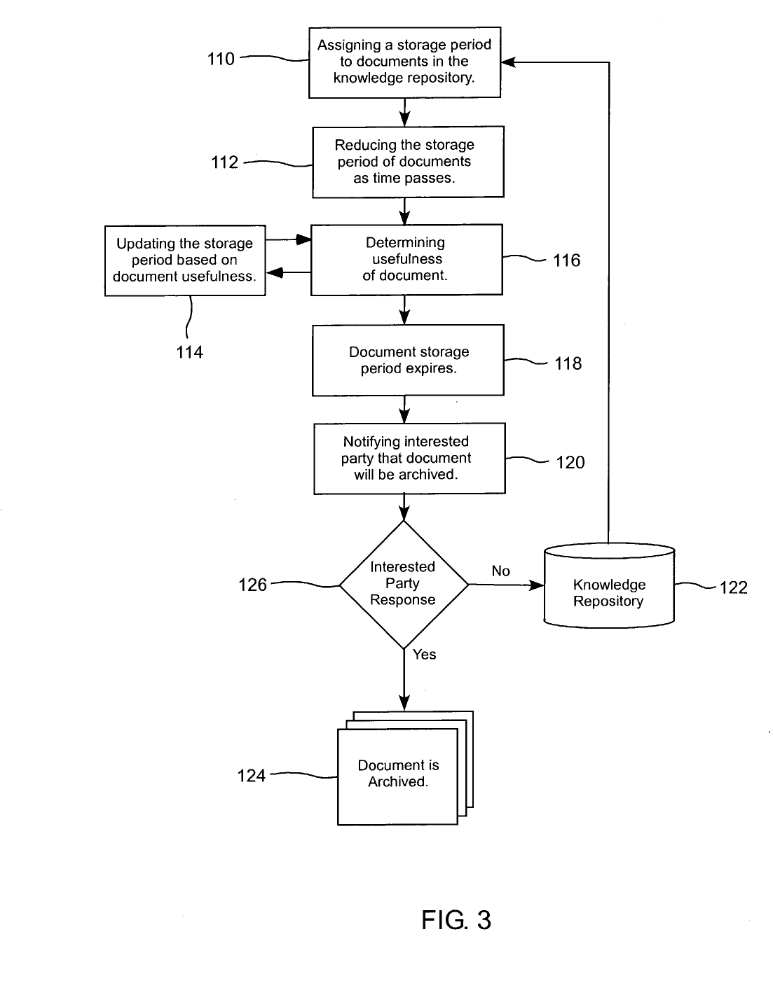

FIG. 3 illustrates a method for removing documents from a knowledge repository when the documents are less useful. The method includes the operation of assigning a storage period to documents in a knowledge repository in block 110. As discussed previously, the storage value may be a counter, time value, date range, or any similar storage period representation. Another operation is reducing the storage period of documents as time passes in block 112. The storage period will be reduced at periodic intervals as time passes. The periodic interval may be a day, hour, week, month, or another specific interval that is predefined by a system administrator. In order to more accurately determine when a document should be removed, the present system includes the operation of determining when documents are useful to a user in block 116. Next, the storage period is updated based on the document usefulness in block 114. The update that takes place can be an increase, a decrease, or no change that is applied to the storage period. At some point in time, the storage period may expire in block 118.

A further operation is notifying an interested party when the storage period of a document has expired. The interested party or author will also be notified that the document will be removed from the knowledge repository and archived within a pre-determined amount of time in block 120. A response can be received from an interested party or author regarding whether or not the interested party wants the document to be retained in the knowledge repository in block 126. If the interested party does not respond to the notification or responds that “yes” the document should be archived, then the document is archived in block 124. If the interested party responds “no” and indicates that they do not want the document to be archived, then the document can be placed back into the knowledge repository in block 122. The interested party will be asked to assign a new storage period to the document. If the interested party does not assign a storage period to the document, then a default storage period can be assigned by the system.

The document removal notification sent to the interested party can be provided by launching the automatic document removal process which checks when documents have an expired storage period. The automatic document removal process can tag documents that should be removed because they have expired storage period or their storage period is now 0. The automatic document removal process can send a communication such as an email or instant message to the interested party, and then the automatic document removal process can wait until the interested party is given a time interval to respond. If the interested party or author does not respond within the time interval, then the document can be archived. Alternatively, if the interested party responds, then the document will not be archived and returned to the knowledge depository as discussed.

Several methods for calculating document usefulness will be discussed that can be applied in the current invention. One of the methods for calculating document usefulness that knowledge management systems currently use is tracking the number of times a document is opened. This helps the system determine which documents are being opened the most. Tracking the number of times a document is opened assumes each time a document is opened that users are using or reading the document. On the other hand, documents that are rarely opened are considered less useful and may be reduced in priority in any search results provided to the user. One problem with this system is a user can open a document and decide that the document is not relevant. Then the user may immediately close the document but the event will still be registered in the document's hit count, thereby making the document appear more relevant.

Alternatively, some documents may have relatively long open times. One reason for this is that a user who opens a document may begin reading a document and then start another task. This is recorded in the system as a document that is open for a long time, although the document is not useful to the user. In addition, the user may be interrupted or leave their workplace and leave the document open. Another example is that the user may switch to another tool or document to find a solution. Each of these situations illustrate that the user is not actually using the document but the system records a very long document open time. Even though document hit counts are not the best indicator of usefulness, document usefulness calculated in this manner can be applied to document storage periods.

Another direct way to capture the usefulness of a document is to ask users to provide feedback after reading a document. However, users are reluctant to provide their feedback. Typically, users do not feel they have time to provide specific feedback on documents. In addition, direct feedback information is sketchy at best because the system cannot identify the competency of individuals giving feedback and the size of the population sample is not controllable.

A more accurate system for determining document usefulness identifies whether or not a reader shows interest in a document, regardless of the document relevance to a given search string query. There is more value in finding document usefulness based on an analysis of aggregate user interactions with each document, as opposed to using the frequency with which the document was opened. This approach addresses users' actual use and reading of a document to determine a document's usefulness.

Whether a document satisfies a user's Boolean query or is frequently opened by users is not the deciding factor in determining if a document contains useful information. A document is actually more useful if the document is conceptually relevant to information that a user is seeking. More specifically, a document can be identified as useful if the document is opened by a user and a substantial portion of the document was read by the user. In addition, the time duration that a document is opened by unique users can indicate how useful the document is to users.

In order to determine the relative useful time duration for an open document, it is desirable to have a plurality of unique users open a given document. Tracking the length of time that several unique users keep a document open provides a data set to help determine what the time open values mean. Additional conditions can also be used to make the final decision about whether a document is useful and to determine the degree of document usefulness. User judgment or the receipt of user feedback can also be used in determining a document's usefulness. As mentioned, users have not historically provided enough actual feedback regarding documents in a knowledge database. When document feedback is provided though, this feedback helps explicitly identify content value. Content value can be further determined by a field domain expert or topic expert, but this evaluation is a time consuming and relatively expensive undertaking.

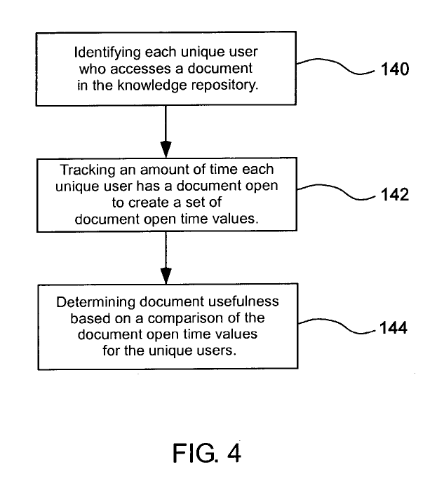

FIG. 4 illustrates a method for identifying useful content in a knowledge repository. The method includes the operation of identifying each unique user who accesses a document in the knowledge repository in block 140. User identification can take place using network connection software, Internet portal software, or similar connection schemes. Another operation is tracking the amount of time each unique user has the document open to create a set of document open time values in block 142. A system process can be provided to track the amount of time that a unique user has a document open. Document usefulness can then be determined based on a comparison of the document open time values for unique users in block 144.

As the size of the set of document values increases, the accuracy of the comparison between the time values will generally improve. Being able to compare the document open times from a large set of time values allows the system to identify outlying values that are not relevant to document usefulness. For example, some documents will be open for two or three seconds and such values are not likely to contribute to the overall usefulness value. The same is true of very large document open values, which probably indicate that a document was opened and forgotten. Accordingly, the storage period of documents may be reduced in ratio to the extent they are a document with outlying values.

Another operation that can be used to determine the document usefulness is based on comparing an individual document time open value to the set of document open time values. This provides instantaneous document usefulness. These instantaneous document usefulness values can be aggregated together to determine the entire usefulness of the document.

In addition to the basic usefulness considerations that use the document open time values and track the unique users who open a document, other variables can also be included in the calculation of usefulness. For example, the following variables can be related to each document:

Direct user feedback.

Frequency a document is opened from a search result list or another knowledge document.

Total number of unique users who have opened a document.

Document ranking in a search list.

Document type.

Document age.

Other criteria that can be used in considering the usefulness of a document are the user's rating of a document on a discrete linear scale (e.g. 1 to 10) and the actual length or complexity of a document. The present invention can also adjust the overall usefulness of a document if the document was deemed useful in a previous time period, such as previous weeks or months.

Document usefulness can even be calculated based on which sections of a document were accessed. If a user accesses the abstract of the document without accessing the key portions of the document, then the system can determine that the time spent in the document was less useful. If the user opens a key portion of the document, then that document access can be considered a more useful access.

The accumulation of document usefulness data can be applied by updating or modifying the storage period of a document. Documents that have a higher usefulness value can have their storage period increased and therefore remain in the knowledge database longer. When documents have a lower usefulness value, they can have their storage period reduced and then those documents will be removed sooner. The documents usefulness value can be used to modify the storage period value. For example, if the document's storage period is stored as a value, then the value can be incremented, decremented or multiplied by a normalized factor.

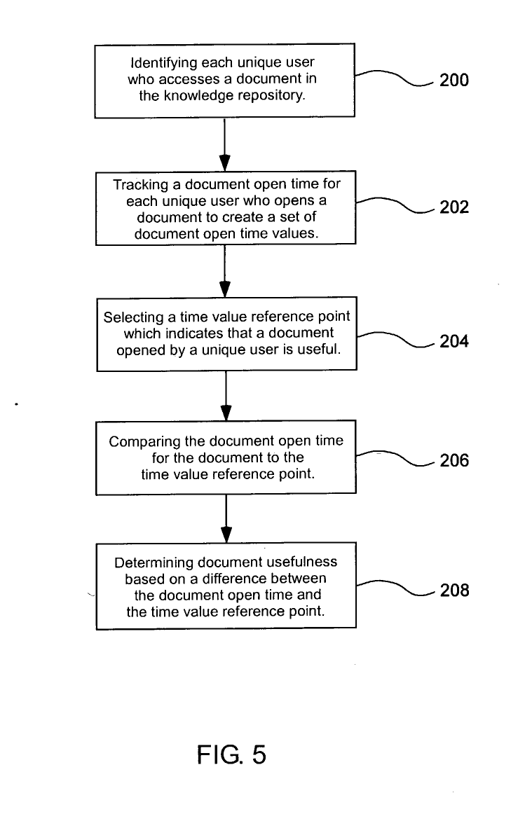

FIG. 5 illustrates an embodiment of the invention that includes a method for identifying useful content in a knowledge repository that is accessed by a plurality of users. This method uses a time value reference point or benchmark against which to gauge document open time values. The method includes an operation of identifying each unique user who accesses the document in the knowledge repository in block 200. This can include tracking whether the same unique user repeatedly accesses the same document. Accordingly, the cumulative time that a unique user accesses a specific document can be recorded. In addition, repeated opening of a document may represent that the document is more useful because the user has accessed the document several times to answer a question or to refer to specific information.

Another operation is tracking a document open time for each unique user who opens a document to create a set of document open time values in block 202. As discussed before, when the set of document time open values becomes relatively large, then the usefulness calculations can be more accurate. A time value reference point is also selected which indicates that a document opened by a unique user is useful in block 204. The time value reference point can be the median of the set of document time values or another useful statistical value. The more detailed use of this time value reference point will be described later. A further operation is comparing the document open time for the document to the time value reference point in block 206. This comparison helps determine the document usefulness based on a difference between the document time open value and the time value reference point in block 208. Again, the document usefulness can be applied to the storage value.

In order for the system and method of the present invention to determine whether a substantial portion of a document has been read, the system must also determine what is defined as a reasonable amount of time that the document should remain open to infer that it has been substantially read.

The present system is able to provide a benchmark for this calculation by collecting data from each user or reader of the document. The collected data creates a set of document open time values. In other words, the set of document open time values can be a list of documents opened by unique users with the amount of time each document was opened by the unique user. A biased standard deviation (SD) of the times in the set of document time open values can be calculated as follows:

$$SD = \sqrt{\frac{{\sum }_{i}^{n} {( {t}_{i} - T )}^{2}}{n}} \qquad \text{Equation 1}$$

Where:

SD is the standard deviation of the time durations that document D has been opened by all the unique users,

tᵢ is a time duration that the document D has been opened at time i,

n is the number of times document D has been opened, and

T is the average time document D has been opened.

This standard deviation value reflects the dispersion of time open durations for a document.

An embodiment of the present invention computes the median time M that the document has been open. A valuable characteristic of the median is its insensitivity to extreme values. The present invention uses the median value as one indicator of a reasonable time that a document should be opened in order to convey some useful information to the reader. Of course, other statistical values can be used as a time reference point.

As the time duration that the document is open decreases from M then the present invention correlates that to a decrease in document usefulness. At the same time, if a document's time duration increases from M, the present system and method correlates that to be a decrease in document usefulness. When a document open time is closer to M, this indicates the document is more useful.

As discussed previously, several analytical reasons exist for this application of the document open values to the benchmark median. Specifically, short open times probably represent that a user was not interested in a document. In a similar manner, long open times probably mean that a user has left the document open while the user was not actually using the document.

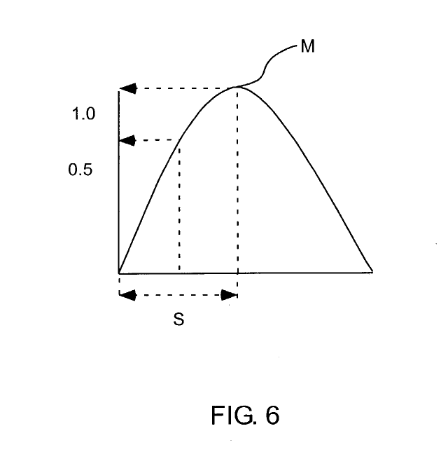

FIG. 6 is a bell-shaped curve that illustrates a set of document open time values in a normal distribution. This function can be viewed as having at least two reference points. The first reference point is the value that is the time value reference point or benchmark value M. In one embodiment, the document usefulness process can use the median for a document as M. Other time value reference points can be used such as the average or a selected value. The second reference point is the half width of the curve S which is the standard deviation from M. Document open time values that fall within a standard deviation from M will be considered useful.

The document time open values will not necessarily be a normal distribution as illustrated and various value distributions may be produced. For example, the distribution may be flatter and wider, taller and narrower, or irregular. In these situations, the standard deviation can be at some other point than the half-width of the curve. Alternatively, intervals other than the half-width can be used for S to define a group of useful documents.

The usefulness uᵢ of the document D, which has been opened at time i for the duration of t is calculated as:

$${u}_{i} = \frac{1}{1 + {( \frac{{t}_{i} - M ( T )}{S} )}^{2}} \qquad \text{Equation 2}$$

This calculation of usefulness provides a decimal value between zero and one. As uᵢ nears zero this indicates that the document is less useful. As uᵢ comes closer to one, the document is more useful (i.e. as it nears the median).

In the equation above,

uᵢ is the usefulness of document D opened for time duration tᵢ,

tᵢ is the time duration document D has been opened at time i,

M(T) is the median time duration that document D has been opened or the median time value reference point,

S is the standard deviation of the time duration that document D has been opened.

Each U value represents the total usefulness of a document to users, assuming that the document was opened a number of times. In other words, Equation 3 is used to calculate a weighted aggregation of the usefulness values uᵢ using the fractional values generated by Equation 2:

$$U = \frac{1}{n - 1} {\sum }_{i}^{n} {u}_{i} \times {W}_{u} \qquad \text{Equation 3}$$

U is final usefulness of a document where n is the total number of times the document has been opened,

uᵢ is the usefulness of the document time at time i,

and Wᵤ is the frequency weight of document U.

The frequency weight Wᵤ of document U is used to normalize the document comparison for all the documents in the database. The frequency weight Wᵤ is normalized by the number of times the most frequently opened document was accessed. The frequency weight is calculated as follows:

$${W}_{u} = \frac{{U}_{n}}{{Max}_{n}} \qquad \text{Equation 4}$$

Where:

Maxₙ is the number of times that the most frequently used document was opened, and

Uₙ is the number of times document U was opened.

Using the method described above, the system can create a list showing the most useful documents and the aggregated degree of their usefulness. Documents that are on the bottom of the list are most likely to be out of the norm.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for automatically removing documents from a knowledge repository, comprising the steps of:
assigning a storage period to documents in the knowledge repository;
reducing the storage period for documents as time passes;
identifying whether documents are useful to users;
updating the storage period of documents based on documents' usefulness to users; and
removing the documents that have an expired storage period.

2. A method as in claim 1, where the step of removing the documents further comprises the step of activating a document removal process to remove the documents with expired storage periods.

3. A method as in claim 1, wherein the step of removing the documents that have an expired storage period further comprises the step of removing documents which have a storage period of zero.

4. A method as in claim 1, wherein the step of removing the documents further comprises the step of activating a document removal process each day to remove the documents with expired storage periods.

5. A method as in claim 1, further comprising the step of notifying an interested party when the storage period for a document has expired and the document will be removed from the knowledge repository.

6. A method as in claim 5, further comprising the step of enabling the interested party to reinstate the document in the knowledge repository by responding to a notification.

7. A method as in claim 6, further comprising the step of removing the document from the knowledge repository if the interested party does not respond to the notification.

8. A method as in claim 6, further comprising the step of enabling the interested party to reassign a storage period to the document when the document is reinstated.

9. A method as in claim 5, wherein the step of notifying an interested party when the storage period has expired for a document further comprises the step of notifying the author when the storage period for a document has expired.

10. A method as in claim 1, wherein the step of reducing the storage period for documents as time passes further comprises the step of reducing the storage period of each document for each time unit that passes.

11. A method as in claim 10, wherein the step of reducing the storage period of each document for each time unit that passes further comprises the step of selecting a time unit from the group of time units consisting of a day, a week, a month or quarter year.

12. A method as in claim 1, wherein the step of assigning a storage period to documents in the knowledge repository further comprises the step of assigning a default storage period to documents in the knowledge repository if no storage period is provided by an interested party.

13. A method as in claim 1, wherein the step of identifying whether documents are useful to a user further comprises the step of identifying useful documents based on a comparison of document open time values for unique users.

14. A method for removing documents from a knowledge repository, comprising the steps of:
assigning a storage period to documents in the knowledge repository;
reducing the storage period of documents as time passes;
determining when documents are useful to a user;
updating the storage period of documents based on documents' usefulness to a user;
notifying an interested party when the storage period of a document has expired and the document will be removed from the knowledge repository; and
removing documents from the knowledge repository with an expired storage period unless the interested party requests that the document remain in the knowledge repository.

15. A method as in claim 14, further comprising the step of enabling the interested party to reinstate the document into the knowledge repository by responding to the notification.

16. A method as in claim 15, further comprising the step of enabling the interested party to reassign a storage period to the document when reinstating the document into the knowledge repository.

17. A method as in claim 14, further comprising the step of archiving the document if the interested party does not reinstate the document into the knowledge repository.

18. A method as in claim 14, wherein the step of reducing the storage period of documents as time passes further comprises the step of reducing the storage period of documents for each time unit that passes.

19. A method as in claim 18, wherein the step of reducing the storage period of documents for each time unit that passes further includes the step of reducing the storage period for each time unit selected from the group of time units consisting of a plurality of hours, a day, a week, a month, and quarter year.

20. A method as in claim 14, wherein the step of removing the documents that have an expired storage period further comprises the step of removing documents that have a storage period of zero.

21. A method as in claim 14, wherein the step of removing the documents further comprises the step of initiating a document removal process to remove documents with expired storage periods.

22. A method as in claim 14, wherein the step of notifying an interested party when the storage period of a document has expired and the document will be removed from the database further comprises the step of notifying an interested party that the document will be archived unless the interested party reassigns a storage period to the document.

23. A system for removing documents from a data storage system when the documents are less useful, comprising:
a knowledge repository which stores a plurality of documents;
a storage period associated with each document;
a document usefulness process in communication with the knowledge repository and configured to determine document usefulness and to update the storage period of documents based on document usefulness;
wherein the document usefulness process is configured to reduce the storage period of documents as time passes; and
a document removal process in communication with the knowledge repository and configured to remove documents from the knowledge repository with expired storage periods.

24. A system as in claim 23, further comprising a web interface that enables the user to access the knowledge repository.

25. A system as in claim 23, further comprising an interested party notification module configured to send a notification to the interested party for a document informing the interested party that the document will soon be removed from the knowledge repository.

26. A system as in claim 25, wherein the interested party notification module enables the interested party to reinstate the document into the knowledge repository.

27. A system as in claim 25, wherein the interested party is an author.

28. A system as in claim 23, wherein the documents are multimedia documents.

29. A system for removing documents from a data storage system when the documents are less useful, comprising:
a knowledge storage means for storing a plurality of documents;
a storage representation means associated with each document for representing a storage period for a document;
a document usefulness means in communication with the knowledge repository for determining document usefulness and updating the storage period of documents;
a storage period reduction means for reducing the storage period of documents as time passes; and
a document removal means in communication with the knowledge repository for removing documents with expired storage periods; and
an interested party notification means for sending notifications to the interested party for a document to inform the interested party that the document will be removed from the knowledge repository.

30. A system as in claim 29, wherein the storage period reduction means is incorporated into the document usefulness means or the document removal means.

31. An article of manufacture, comprising:
a computer usable medium having computer readable program code embodied therein for automatically removing documents from a knowledge repository, the computer readable program code means in the article of manufacture comprising:
computer readable program code for assigning a storage period to documents in the knowledge repository;
computer readable program code for reducing the storage period for documents as time passes;
computer readable program code for identifying whether documents are useful to users;
computer readable program code for updating the storage period of documents based on documents' usefulness to users;
computer readable program code for notifying an interested party when the storage period for a document has expired and the document will be removed from the knowledge repository; and
computer readable program code for removing the documents that have an expired storage period.
